(19) United States
(12) Patent Application Publication
(10) Pub. No.: US 2001/0054517 A1
(43) Pub. Date: Dec. 27, 2001

(54) Methods and apparatus for recording information via at least two mediums

(76) Inventors: Mark Conklan, Acworth, GA (US); Mark Darty, Collierville, TN (US); Rodney Loyd, Cordova, TN (US); Kevin O' Neill, Atlanta, GA (US); Yoshiaki Komatsu, Yokkaichi (JP); Tsuyoshi Ohashi, Hashima (JP); Takemi Yamamoto, Nagoya (JP); Yuzo Fukunaga, Nagoya (JP); Shigeru Kagayama, Owariasahi (JP); Yoshiyuki Kaneno, Nagoya (JP); Kazunari Taki, Nagoya (JP); Ryohei Komiya, Nagoya (JP)

Correspondence Address: Oliff & Berridge PLC, P.O. Box 19928, Alexandria, VA, 22320, US

(21) Appl. No.: 09/752,775

(22) Filed: Jan. 3, 2001

Related U.S. Application Data
(60) Provisional application No. 60/174,307, filed on Jan. 3, 2000.

(51) Int. Cl. G06K 11/06; G08C 21/00

(52) U.S. Cl. 178/18.01

(57) ABSTRACT

An apparatus for recording information includes a writing device that can be manually manipulated to record information on at least one sheet. An electronic device receives the information recorded on the at least one sheet. The apparatus therefore substantially simultaneously records information on at least two mediums.

### BACKGROUND OF THE INVENTION

1. Field of Invention

This invention relates to methods and apparatus for recording information, such as images and/or sounds, via at least two mediums, such as electronically and conventional audible and/or written records.

2. Description of Related Art

Conventional devices, such as pens, pencils, paper, tape recorders and the like, have been used to record information, such as by taking notes, either audibly or in writing. Recently, personal digital assistants (PDA) and personal computers have decreased the need for conventionally recording information because of their versatility. For example, PDA's, such as the Palm Pilot® or Cassiopeia® brands, have made it possible to digitally write information into the device, and download the information into a determining device, such as a computer. The information is written in a short hand alphabet, which cannot be viewed visually, and then is converted to a normal alphabet. PDA's, as well as laptop computers, are especially convenient because they enable a user to record information at any location.

Devices such as the Franklin planner binder kits® brand combine the use of a PDA with a standard note pad. This combination provides a conventional device as well as an electronic device for recording information in the same binder. However, the information recorded by the PDA and the standard note pad are not communicated with each other.

Wireless touch pads also exist which allow a user to write on the pad using a standard alphabet. The information can then be transferred to a computer. Wireless touch pads are somewhat user friendly because a user can view the images being written onto the pad. However, the wireless touch pads only allow electronic information to be stored.

### SUMMARY OF THE INVENTION

As discussed above, devices, such as PDA's, laptops, Franklin planner binder kits® brand and wireless touch pads, provide for the recordation of information via multiple mediums. However, these devices do not allow a user to simultaneously information via at least two mediums, such as electronically and conventional audible and/or written records. This limitation limits the flexibility and versatility of these devices.

It is therefore desirable to provide methods and apparatus for simultaneously recording information via at least two mediums in order to enhance a user's flexibility in recording information.

This invention therefore provides methods, systems and devices for achieving this flexibility in recording information.

This invention can separately provide methods, systems and devices that have audio recording and playback capabilities.

This invention can separately provide methods, systems and devices that time stamp recorded audio and written information.

This invention can separately provide methods, systems and devices with the ability to play back recorded audio that corresponds to written information.

This invention can separately provide methods, systems and devices that have a keyboard and LCD display for inputting and displaying information.

This invention can separately provide methods, systems and devices that have the ability to upload information recorded via written or audio inputs to a determining device, such as a computer.

For example, an apparatus for recording information in accordance with an embodiment of the invention includes a writing device that can be manually manipulated to record information on at least one sheet. An electronic device receives the information recorded on the at least one sheet. Thus, the apparatus substantially simultaneously records information on at least two mediums, i.e., the at least one sheet and the electronic device.

The electronic device can digitally record the information recorded on the at least one sheet.

The writing device can be a pen that records the information on the at least one sheet via ink.

The writing device can include an electromagnetic transmitting device that emits a wireless signal of a designated frequency and frequency information content. The electromagnetic device can be disposed at one end of the writing device. The writing device may further include another electromagnetic device disposed at another end of the writing device opposite to the one end. Further the electromagnetic device can add information to be received by the electronic device and the other electromagnetic device can erase information from the electronic device.

The writing device can record information on the sheet and communicate the information to the electronic device in multiple colors.

The electronic device can include a microprocessor that performs control, data acquisition and communications functions.

The electronic device can include flash memory, RAM and ROM, which enable the information received from the writing device to be stored.

The electronic device can include electromagnetic induction coils that receive signals transmitted from the writing device and convert the signals into a digital representation corresponding to the information recorded on the at least one sheet.

The at least one sheet can be disposed directly on top of the electronic device.

A method of recording information in accordance with an embodiment of the invention can include the steps of recording information on at least one sheet, and receiving the information recorded on the at least one sheet with an electronic device. The recording and receiving steps can occur substantially simultaneously. The recording step can include manually manipulating a writing device.

These and other features and advantages of this invention are described in or are apparent from the following detailed description of various exemplary embodiments of the systems and methods according to this invention.

### BRIEF DESCRIPTION OF THE DRAWINGS

Various exemplary embodiments of this invention will be described in detail, with reference to the following figures, wherein:

FIG. 1 illustrates one exemplary embodiment of a device in accordance with the invention;

FIG. 2 is a schematic diagram of circuitry of the device of FIG. 1;

FIG. 3 illustrates a configuration of magnetic inducting coils of the device of FIG. 1;

FIG. 4 illustrates another exemplary embodiment of a device in accordance with the invention;

FIG. 5 illustrates yet another exemplary embodiment of a device in accordance with the invention;

FIG. 6 is a schematic diagram of the circuitry of the device of FIG. 5;

FIG. 7 illustrates a device for communicating with various modules of the device of FIG. 5;

FIG. 8 illustrates still another exemplary embodiment of a device in accordance with the invention;

FIG. 9 illustrates the device of FIG. 8;

FIG. 10 illustrates still another exemplary embodiment of a device in accordance with the invention;

FIG. 11 is a perspective view of the device of FIG. 10;

FIG. 12 is a top plan view of the device of FIG. 10;

FIG. 13 is a bottom plan view of the device of FIG. 10;

FIG. 14 is a front plan view of the device of FIG. 10;

FIG. 15 is a rear plan view of the device of FIG. 10;

FIG. 16 is a left side plan view of the device of FIG. 10;

FIG. 17 is a right side planview of the device of FIG. 10; and

FIG. 18 is a perspective view of the device of FIG. 10.

### DETAILED DESCRIPTION OF PREFERRED EMBODIMENTS

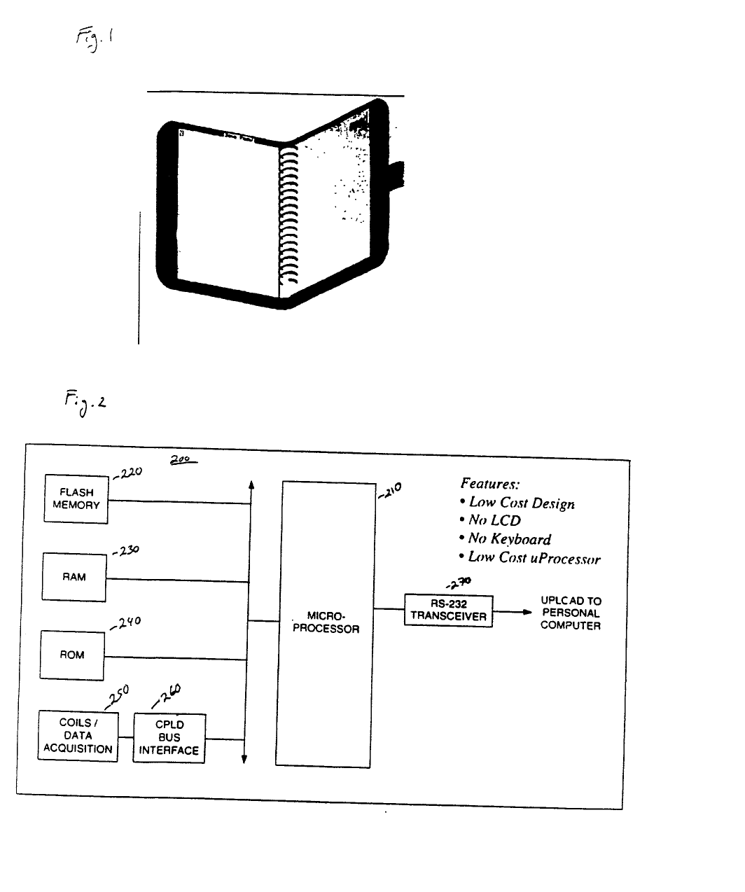

FIG. 1 shows a device according to one embodiment of this invention. The device in accordance with this exemplary embodiment allows a user to digitally record the information or drawings that the user writes on notebook sheet. The device can be used with any type of notebook or with different writing media, such as with any type of paper.

When a user writes on the notebook sheet, the electronics contained within the device record a digital representation of the pen strokes on the sheet. The device can be supplied with a special writing tool, such as a pen, pencil or other similar writing instruments, for transferring data to the electronics of the device.

The writing tool can contain an electromagnetic transmitting device at either or both ends of the writing tool that emit a wireless signal of a designated frequency and frequency information content. The writing tip of the writing tool can emit a unique signal and the other end or eraser can emit another different signal. Therefore, the different signals can indicate to the electronic system of the device which end of the writing tool is being used, as well as its function and writing characteristics. Thus, the system can determine whether the writing tool is writing or erasing. The system can also determine the color of ink and store this information accordingly.

The writing tool can write in various colors. Therefore, a unique frequency and signal content for each color can be used so that the electronic system of the device can determine which color is being used and accurately represent the digital representation of conventional writing recorded on the notebook sheet. When the user writes on the paper, which is contained in the notebook, the location of the pen or other writing tool is communicated to the electronics of the notebook.

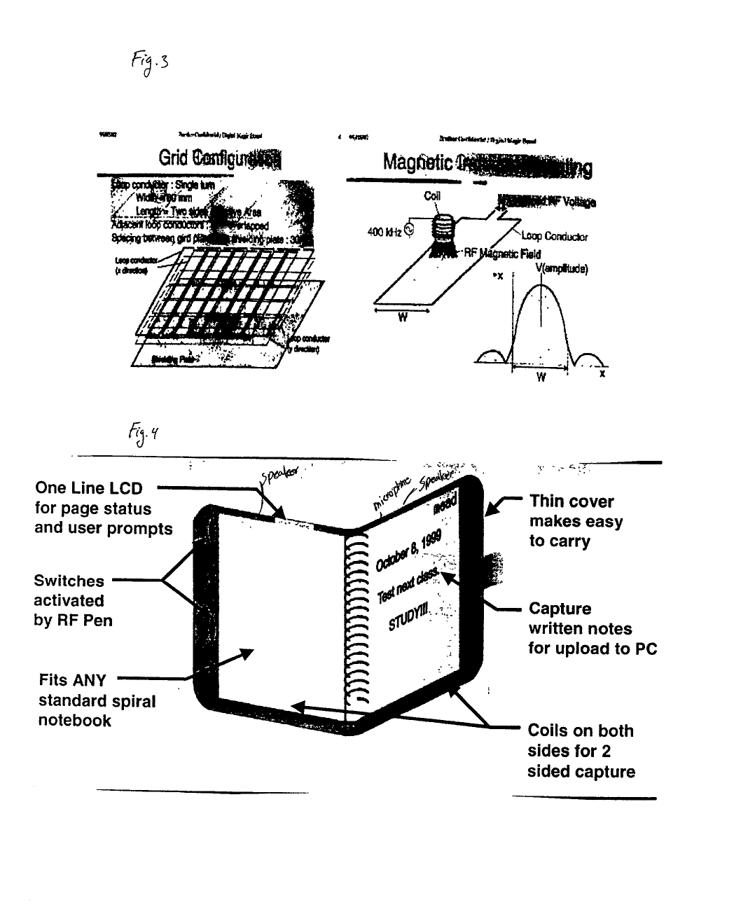

The device can have several electronic components that control the functions of the device. As shown in FIG. 2, the device can contain a microprocessor 210. The microprocessor 210 controls the various control, data acquisition and communications functions of the device. The microprocessor 210 processes the received data from the writing tools, and then either stores the data in memory and/or uploads the data to an external computer.

The microprocessor 210 also controls any internal processes. The electronics contain flash memory 220, RAM 230 and ROM 240. These memory devices allow the information received from the writing tools to be stored for later access or uploading to a computer. The coils/data acquisition 250, receives the signals from the writing devices. These signals are then converted into a digital representation corresponding to the written data on the notebook sheet.

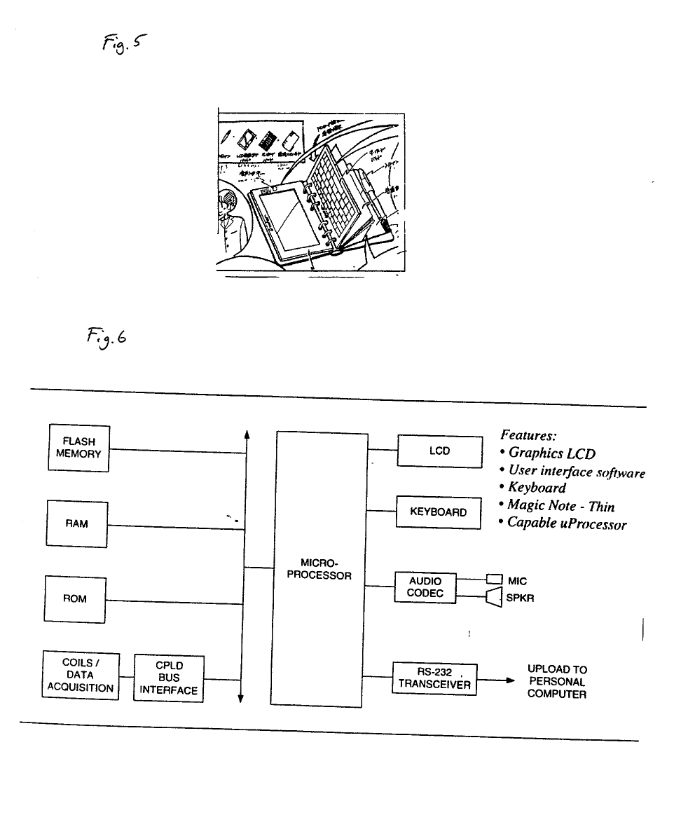

The device contains an array of signal receiving coils, as shown in FIG. 3. The coils are electromagnetic induction coils. The coils pick up signals from the writing tool and process these signals.

The coils are located within the device on either or both sides, as shown in FIG. 2. This location allows the user to write on either side and still have the data digitally processed.

The signal receiving coil array is a grid, where each coil is formed by a specified width and spaced from each other by a desired length. The width and length can be changed depending upon the desired performance of the coils. The coil loop is a specific width.

The electromagnetic field generated by the writing tool induces a current into a signal receiving coil loop within a specified distance from the writing tool. The induced current in the coil is then used to create a voltage in a measurement circuit. The circuit voltage is then measured, and the measurement is used to represent the electromagnetic field strength of the given coil. The exact location of the writing tool above the signal receiving coil grid can be determined by comparing relative signal strength between adjacent coils in both dimensions of the two dimensional writing surface.

The data from the writing tool, as it traverses the coil array, is received and stored in memory. This is accomplished by first scanning the pick-up coils, and converting the analog signal into a digital signal. The coils can all be scanned at one time.

Alternatively, only selective coils, which correspond to the position of the pen, can be scanned, and the analog data converted to digital data, which may be desirable. To perform the selective coil scanning operation, the coils are scanned periodically with interim scans of only those coils around the last known writing device location. This selective coil scan can increase the equivalent scan rate and produce more data points on the writing location per unit time, which equates to higher resolution of the writing location data.

After each writing location data scan, the data is analyzed and the highest three coil values in each axis are saved into memory. The highest data value of the three coil values in each axis corresponds to the general location of the writing device. The second highest value, enables a determination to be made as to which side of the center of the highest value coil the writing device is on. The difference between the highest two adjacent signals is taken at each position along the width of the coil. This allows for better data acquisition and eliminates common mode noise.

Before the device is used, the characteristic response of a given pen and signal receiving coil array design must be known. This is accomplished through a calibration process which precisely measures the response of three adjacent coils when the writing tool is at a known distance above the surface of the writing surface. This data depicts the reference response when the writing tool is resting on the plane of the coil array.

The reference data is taken at even intervals along the distance of the width of three coil loops. Specifically, the peak amplitude difference between two adjacent receiving coil signals, at precise intervals over a segment of the middle coil width, when the pen is resting on the surface of the writing tablet, is used to form a reference system response. Thus the difference of the two greatest coil signals in each dimension can be used to determine the exact location of the pen in each dimension. This reference or characteristic performance data forms a position resolving table (PRT).

The data in the PRT is then used to create an equation describing the curve generated by plotting the raw PRT data. By fitting this data with a polynomial equation, a smooth or continuous representation of the data can be used. Therefore, for a given measured voltage corresponding to the writing device signal, there is no round up or round down error, as would exist if the real data were compared to reference values in a look-up PRT table. In some cases, when signal noise is present, several position points are averaged to eliminate the effects of the signal noise in the measurement of the signal.

The equation is used to model the change in difference of the signal between adjacent coils with respect to distance. Typically, a polynomial of the n^{th} order will accurately fit this data. In an exemplary embodiment of the invention, a 7^{th} order polynomial has been found to adequately represent the PRT table data. Therefore, a PRT equation is generated to provide a continuous representation of the characteristic performance of the coil array and associated circuit.

After calibration and during operation of the device, the electronics measure the receiving coil signals many times per second. The difference in the two highest coil signals in each dimension is then used to solve the characteristic PRT equation for the location of the writing tool. This method yields good results because the PRT equation is accurate enough to predict the performance of the system under most operating conditions.

With the X and Y positions of the writing device known for each increment in time, an electronic database of the writing device location history can be built that depicts the drawing and writing on the notepad sheet. Additionally, a data smoothing algorithm can be applied, either in software within the device or as a post processing feature of computer software, that acts on the data after upload to the computer. The purpose of such data smoothing is to eliminate any noise or data errors that occur quickly in time and affect only a few points of the positional data.

Once the writing data has been stored in the memory of the device system, it can be uploaded to a computer or similar apparatus. The computer can be loaded with software that is especially written for the device. The computer software can be compatible with the software contained in the device itself and makes it possible to upload data to the computer. The data is transferred between similar communications ports contained in the device and computer. Once the data is transferred to the computer, the software can display the data, manipulate the data, i.e., cut, paste etc. or transfer the data to other software programs.

One exemplary embodiment of the computer software can apply business productivity templates to the data that correspond to paper templates for use with the device. These templates could provide business tools such as calendars, to-do and appointment lists, telephone and personnel contact information, etc. that can then be used by a variety of computer and Internet software programs. The software written for the device can be compatible with various operating systems and can easily be modified for any later developed operating systems. The software can also be compatible with several other software programs such as Microsoft office programs or CAD drawing programs. This allows the user to have extreme versatility in the manipulation of the data obtained from the device. The data can be manipulated by the software written for the device or by other programs.

Another exemplary embodiment of this invention is shown in FIG. 4.

FIG. 4 shows a device similar to that of FIG. 1. The device in FIG. 4 contains all the features of the device in FIG. 1, but contains the added features of speakers, microphone and LCD display. The microphone allows the device to receive voice or sound data. This data can be then played at a later time through the speakers or the data can be used for editing, storing, etc. on a computer.

The device contains an audio chip where the audio chip has an integral analog to digital converter. A digital voice or sound compression algorithm or technique is used to compress the voice and sound data. The compression algorithm and technique can be any number of known or later developed algorithms and techniques for compressing voice and sound data. The audio chip communicates with the microprocessor by using a logic circuit implemented in a programmable logic device. The digital voice data is stored in memory contained in the electronic system of the device.

Once the audio data is obtained, the analog signal is converted to digital. A time stamp is then attached to each digital sampling of the audio data. The audio data with the time stamp is then held in memory for later use. When the user uses the writing tools to write with, the written data is also time stamped. The time stamped audio data and the time stamped written data are then synchronized in time with each other and stored in a database. Each audio segment can subsequently be referenced to individual writing tool pen strokes.

Software contained in the device is used to playback the audio data. The audio data that is obtained during a certain written data segment can be played back. This allows the user to hear the audio version of what was being said during the time that the user was writing a certain section of written notes or data.

The user can touch the writing tool to any previously recorded written mark and the corresponding audio will play for the time frame. The audio data can also be played and the corresponding written data can be displayed on a computer after data upload from the device. The audio data and written data can be correlated to each other by small written data strokes, whole lines, drawings, individual pages and/or any segment of audio or written data.

The device in FIG. 4 can contain several buttons and switches that are used to control the features of the device. These buttons and switches can be activated manually or by the writing tool. Several buttons and switches control the audio features of the device. These audio buttons and switches can include features, such as play, record, stop, correlate with written data, etc. Any other features that control the functions of the audio data can be implemented into a button or switch or any other type of activation mechanism for those features.

The device in FIG. 4 can also contain a LCD display. This LCD is used to display the page status and/or user prompts. The page status can indicate to the user which page the user is working on. The page status can also indicate to the user which page and segment of written data corresponds to audio data that is played. The LCD also provides user prompts. This allows the user to know what features of the device are being used and to let the user select those features.

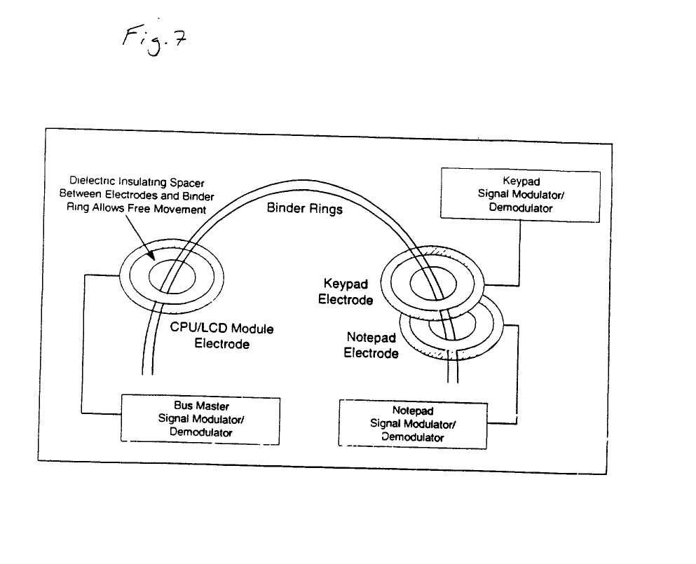

FIG. 5 shows another exemplary embodiment of this invention. FIG. 5 shows the device of FIG. 4, with the added features of a keyboard and large LCD screen for viewing graphics as well as text. The keyboard and large LCD screen in combination can be a PDA system or personal digital assistant, such as those previously discussed. The PDA system would provide the user with all the features of current PDA system, such as, calendars, day planners, phone and address lists, calculators and clocks. These items, in combination with the features of the device in FIG. 4, allow for greater versatility in obtaining and storing information electronically as well as conventionally on paper or other media.

The keyboard and large LCD screen are made very thin, and are both able to fit into the device of FIG. 5. This structure provides all the features of FIGS. 4 and 5 together in one environment. The keyboard and LCD screen are held in the device of FIG. 5 by rings. The keyboard and LCD screen have holes in their edges so that they fit through the rings.

FIG. 6 is a schematic diagram of the circuitry of the device of FIG. 5. The device of FIG. 5 can contain the same electronics as the device shown in FIG. 2, but with the added keyboard, LCD and audio elements. The keyboard and LCD are connected to the microprocessor, which controls their functions and processes the software needed to run the PDA features. The audio elements include speakers and microphones connected to an audio coding and decoding element. This audio coding or decoding element is connected to the microprocessor.

The audio that is received through the microphone is coded in the audio codec and then stored in memory. The microprocessor controls these functions. If this audio is to be played, the microprocessor obtains the data and then it is decoded in the audio. After decoding the data, the audio can be played through the speakers incorporated into the device. Alternatively, the audio can be played through computer multimedia systems.

FIG. 7 illustrates a device for communicating with various modules of the device of FIG. 5, wherein two electronic modules can communicate using a time varying electronic signal, each communicating module having the necessary hardware and software to encode/decode or modulate/demodulate the communications signal. This apparatus works by allowing each of the communicating modules to send and receive data via a serial communications link. The serial communications link is established between two modules (where each module is physically separated from the other but both are residing as part of a ring bound notebook). The serial communications is established first as a digital electronic signal on a given module (say module A), then it is changed to a time varying analog electronic signal and modulated or encoded.

An electronic signal amplifier boosts the voltage or current characteristics of the signal and a ring electrode is energized with the signal. The ring electrode then contains electrical charge that creates an electric field whose greatest strength is along the axis of the ring electrode. Since the ring electrode slides along the metal notebook ring binder, the electric field generated by the ring electrode is coupled onto the metal ring binder and the communications signal is carried by that electric field, therefore the communications signal is now carried by the ring binder of the notebook. The induced communications signal is carried across the notebook to the receiving module where now the binder ring emits an electric field that is coupled onto the ring electrode of the receiving module. In the receiving module, a circuit connected to the ring electrode is used to demodulate or decode the incoming signal. The process is reversed for communications in the reverse direction between modules. In this manner, a serial communications system can be established between two modules.

A serial local area network having several modules in communications can be established by simply encoding data as packets with headers and footers that specify the receiving or transmitting party. The signal is coupled between the ring binder and the ring electrodes in the modules by electric field means and therefore can be of amplitude modulated, frequency modulated or digital time varying signal types.

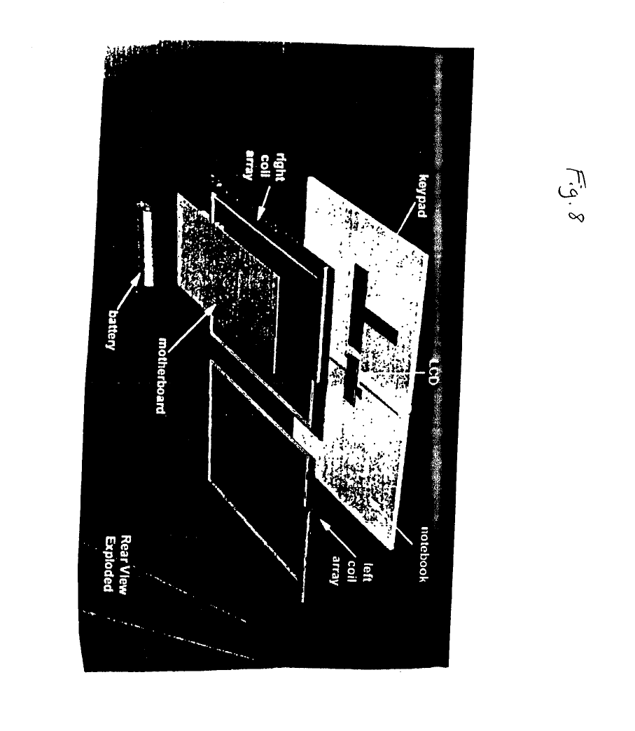

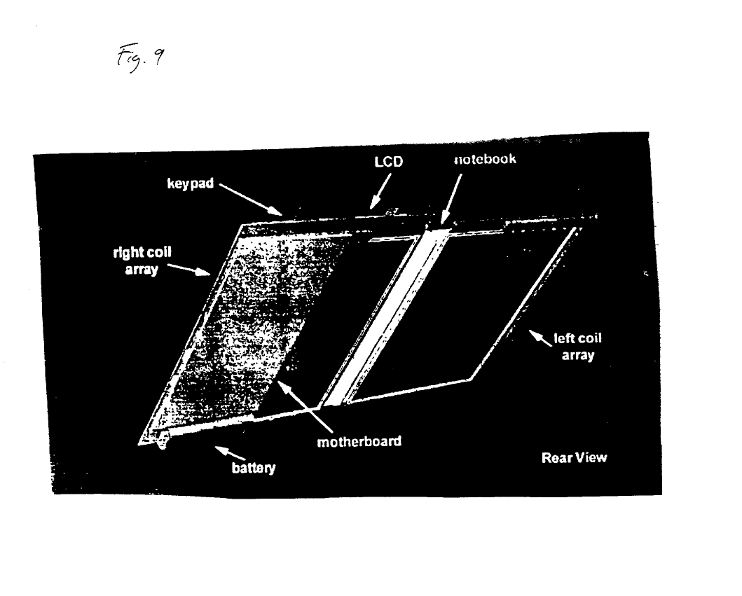

FIGS. 8 and 9 show the structure of another exemplary embodiment of this invention. An electronic keypad and LCD are positioned at the top of the notebook. The right and left coil arrays are positioned behind each side of the notebook, thus allowing the user to write on both sides of the notebook and still be able to record the writing electronically. The motherboard is positioned behind the right coil array. The motherboard controls the operations and functions of the notebook. The batteries are then placed behind the motherboard. It should be noted that various other arrangement of the keypad, LCD coil arrays, motherboard and batteries are possible.

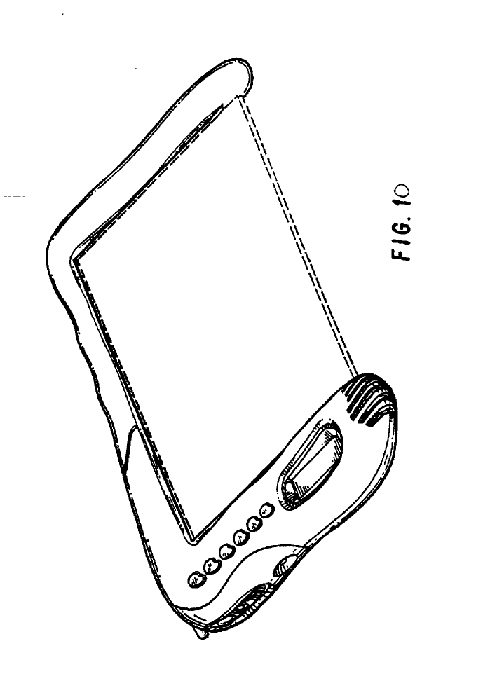

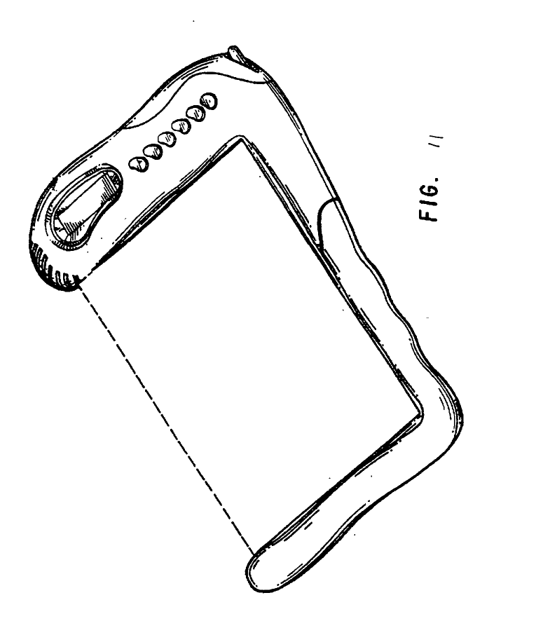

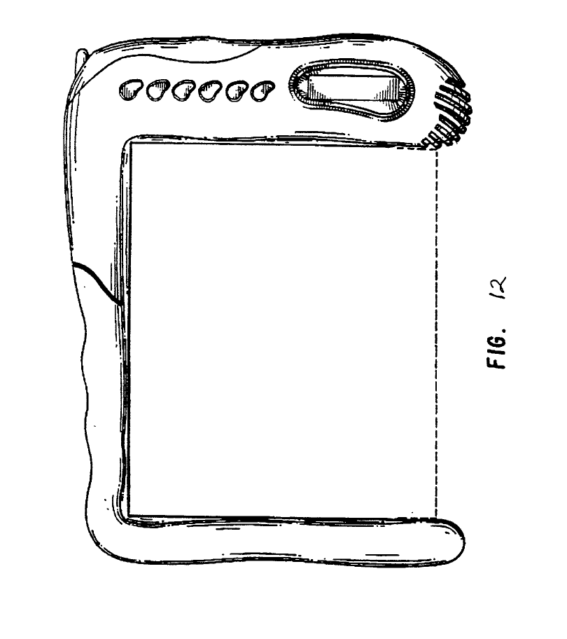

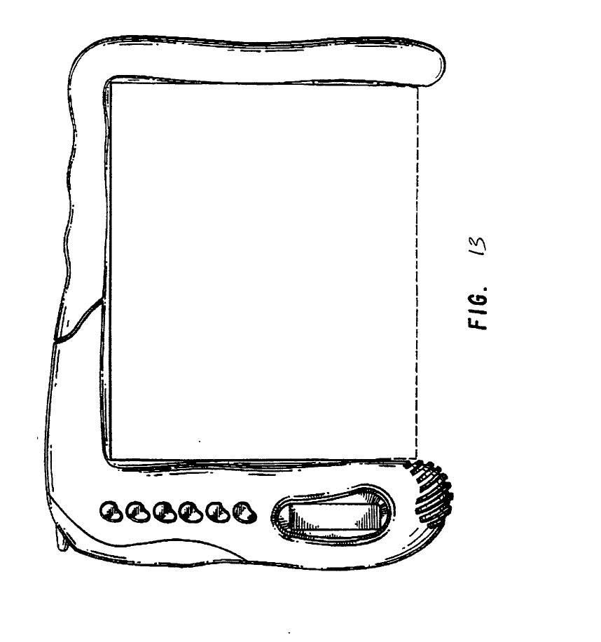

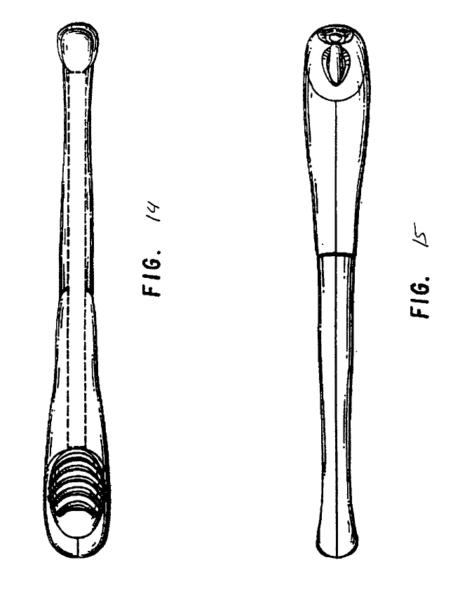

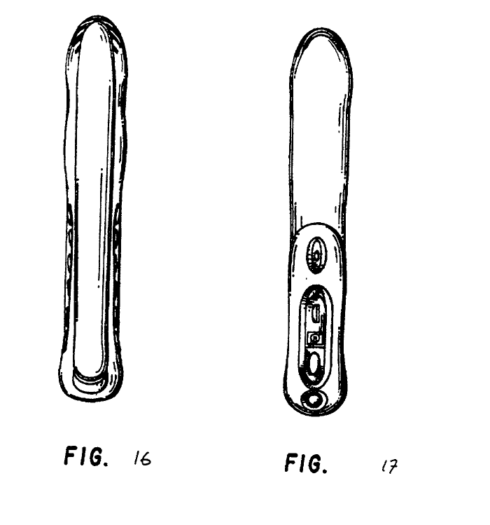

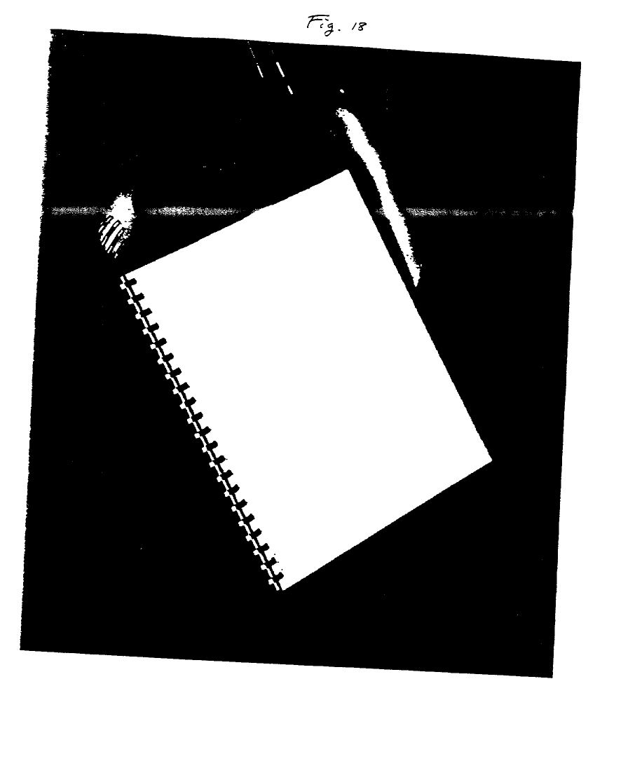

FIGS. 10-18 show another exemplary embodiment of this invention at various angles and views, i.e., front, back, sides, etc. FIG. 18 shows the embodiment with a spiral notebook attached to the device. FIGS. 10-18 can contain parts or all of the features described above.

FIGS. 10-18 contain a middle section that contains the coil arrays. There are two sets of coil arrays, one on each side of the middle section. This structure is provided so that when a notebook is placed in the device, the writing can be recorded electronically on both sides. The electronics of the device are contained within the side structure. These electronics control the operations and functions of the device. The notebook is placed at the middle section and is held there by a sleeve. The ends of the notebook slide into the sleeve locking it into place. It should be noted that any other mechanism or method for holding a notebook or writing sheet in place can be used.

The embodiments of FIGS. 10-18 contain several buttons and switches that are used in the operation of the device. These include buttons and switches for turning the device on and off. Controls for audio, such as play, stop, record, fast forward, reverse, pause, delete, and any other current or future controls that can be used in audio operations. A button or switch is also provided to control the volume of the audio. The buttons and switches operate features of the device such as next page or back page. The LCD screen can display any number of functions which can be selected by a scrolling button or switch. The LCD screen can also display how much memory is being used or how much is left, how many pages one document contains etc.

The embodiments of FIGS. 10-18 can also contain ports for connecting to other computer devices. These ports include any number of serial, parallel, infrared or any other known or later developed ports that connect one device to another. The embodiment of FIGS. 10-18 may also contain a connector for connecting to an external power source. This connector can be any number of known or later developed connectors for connecting to an external power source. The batteries used may be standard cell batteries or any known or later developed rechargeable batteries.

The embodiments of FIGS. 10-18 show a pen that can be placed in a slot, which is located at a side edge of the device. The pen can be locked into the slot. When the pen is needed, it can be easily taken out of the slot and used.

The embodiments of FIG. 10-18 also show a speaker located on the corner edge of the device. The speaker can be used to relay audio data to the user of the device.

The device in the embodiments of FIGS. 10-18 contains all the features and mechanisms of the device on both sides of the device. Therefore, a user can flip the device over and have all the same functions and perform all the same operations. Thus, if the user wants to write on the other side of the notebook or any other writing material that is place on the device, then the user does not have to flip the device back and forth in order to perform a specific function or operation.

While this invention has been described in conjunction with the exemplary embodiments outlined above, it is evident that many alternatives, modifications and variations will be apparent to those skilled in the art. Accordingly, the exemplary embodiments of the invention may be made without departing from the spirit and scope of the invention.

What is claimed is:

1. An apparatus for recording information, comprising:
a writing device that can be manually manipulated to record information;
at least one sheet on which information can be recorded with the writing device; and
an electronic device that receives the information recorded on the at least one sheet.

2. The apparatus according to claim 1, wherein the electronic device digitally records the information recorded on the at least one sheet.

3. The apparatus according to claim 2, wherein the writing device is a pen that records the information on the at least one sheet via ink.

4. The apparatus according to claim 3, wherein the writing device includes an electromagnetic transmitting device that emits a wireless signal of a designated frequency and frequency information content.

5. The apparatus according to claim 4, wherein the writing device substantially simultaneously records information on the at least one sheet and communicates the information to the electronic device.

6. The apparatus according to claim 5, wherein the electromagnetic device is disposed at one end of the writing device, and the writing device includes another electromagnetic device disposed at another end of the writing device opposite to the one end.

7. The apparatus according to claim 6, wherein the electromagnetic device adds information to be received by the electronic device and the other electromagnetic device erases information from the electronic device.

8. The apparatus according to claim 7, wherein the writing device can record information on the at least one sheet and communicate the information to the electronic device in multiple colors.

9. The apparatus according to claim 8, wherein the electronic device includes a microprocessor that performs control, data acquisition and communications functions.

10. The apparatus according to claim 9, wherein the electronic device includes flash memory, RAM and ROM, which enable the information received from the writing device to be stored.

11. The apparatus according to claim 10, wherein the electronic device includes electromagnetic induction coils that receive signals transmitted from the writing device and convert the signals into a digital representation corresponding to the information recorded on the at least one sheet.

12. The apparatus according to claim 11, wherein the at least one sheet is disposed directly on top of the electronic device.

13. A method of recording information, comprising the steps of:
recording information on at least one sheet; and
receiving the information recorded on the at least one sheet with an electronic device.

14. The method according to claim 13, wherein the recording and receiving steps occur substantially simultaneously.

15. The method according to claim 14, wherein the recording step includes manually manipulating a writing device.

16. An apparatus for recording information, comprising:
at least one sheet;
means for recording information on the at least one sheet; and
means for electronically receiving the information recorded on the at least one sheet.
